(19) United States
(12) Patent Application Publication
(10) Pub. No.: US 2012/0037772 A1
(43) Pub. Date: Feb. 16, 2012

(54) Locker mounting apparatus for work belts

(76) Inventor: Christopher Aaron Inglehart, Santa Fe, NM (US)

(21) Appl. No.: 12/806,517

(22) Filed: Aug. 16, 2010

(51) Int. Cl. F16M 13/02

(52) U.S. Cl. 248/224.8

(57) ABSTRACT

A mounting apparatus to be coupled to louver vents disposed in locker doors for the purpose of hanging or otherwise supporting work or duty weight bearing belts used by professionals in general, and law enforcement personnel in particular. A planar member adapted to be positioned adjacent the outer surface of the locker door has at one end thereof a flange depending therefrom at an oblique angle with respect to the planar member, the flange being adapted to be positioned over a louver vent. The end of the planar member opposite the flange depends into a uniform spacing member that is adapted to engage the outer surface of the locker door to create a gap between the planar member and the surface of the locker door. An aperture is disposed through the planar member adjacent the spacer which is adapted to receive the buckle engagement member of the work belt.

### BACKGROUND OF THE INVENTION

1. Field of the Invention

The present invention generally relates to apparatus adapted to be coupled to the door of a wall locker to hold and organize personal effects and in particular to support the heavy duty belts used by law enforcement personnel.

2. Description of the Prior Art

Hangers of the type employed for clothing that include a support frame and hook are well known in the prior art and commonly used in a conventional manner. Such conventional manner normally calls for clothing to be folded over and supported from a support arm having its opposite ends connected generally to brace elements connecting the support arm to a hook portion. The brace elements converge at a junction whereat the supporting hook is normally removably attached within a closet or the like on elongate rods. While theSe hanger structures are obviously well accepted, they generally are not usable in wall lockers found in schools, gymnasiums or other locations where temporary storage is needed.

Wall lockers typically used for the storage of clothing and the like typically include louvered vents in the locker door. The user of such facilities typically place their street clothes or other items for storage within the wall locker. In order to conserve space, such lockers are not specifically dimensioned or internally structured for adaptation to the use of conventionally configured clothes hangers. As a result, users are required to hang their clothes on support hooks typically attached to the inside vertical walls of the wall locker or otherwise fold or arrange clothing and other items to fit within the limited space. Wall lockers configured in this manner are unusable for hanging or otherwise mounting heavy work or duty belts.

The prior art does disclose supporting apparatus that can be removably coupled to the louver vents of locker doors. In one embodiment disclosed by the prior art, a multiple shelf system is employed with bins that may be used to hold the user's accessories. The device is inadequate for use to store or otherwise mount the work or duty belts employed by law enforcement personnel, carpenters or plumbers because of the weight and bulkiness inherent in the belts.

The present invention substantially resolves the inadequacies of mounting apparatus taught by the prior art. Duty belts employed by law enforcement officers are intended to carry bulky items that can weigh at least 30 pounds. Work belts employed by members of the military, carpenters and plumbers typically weigh approximately the same. The devices taught by the prior art are totally incapable of supporting bulky items in general and heavy bulky items in particular in the manner achieved by the present invention. The present invention comprises a planar member, one end thereof being supported by a louvered vent in a locker door. The planar member is spaced from the surface of the locker door and includes a receiving aperture for receiving the work belt securing flanges that are necessitated by the substantial weight to be carried by duty and work belts. The present invention also employs a member extending outwardly from the planar member to support items of clothing and other items not required to be supported by the weight bearing member.

### SUMMARY OF THE INVENTION

The present invention is a mounting apparatus for heavy duty and work belts used by law enforcement officers, members of the military and other professionals (e.g., plumbers, carpenters, etc.) that support heavy and bulky items indigenous to their professions. The present invention is intended to provide support for duty and work belts that support loads that can be as heavy as 30 pounds. A planar member having parallel front and rear surfaces depends at one end thereof into a mounting flange that is deflected at an oblique angle relative to the surface of the planar member and is adapted to engage the louver vent of the door of a wall locker. The opposing end of the planar member depends into a perpendicular spacing panel that engages the surface of the locker door and creates a gap between the locker door and the surface of the planar member. An aperture or opening is disposed through the planar member from one surface to the other substantially adjacent the spacing panel. Belt coupling members of heavy duty and work belts typically comprise at least one curved member at one end of the belt that are adapted to be engaged with apertures disposed at the opposing end of the belt. The belt coupling members of a work belt are positioned into the opening and adapted to engage the surface of the planar member at the lower edge of the aperture. To mount standard clothing or other accessories, an auxiliary mounting member is secured to the surface of the planar member in opposition to the spacer. It is therefore an object of the present invention to provide a locker mounting apparatus to support weight bearing work and duty belts.

It is another object of the present invention to provide a locker mounting apparatus for supporting work or duty belts that is removably coupled to the door of a wall locker.

It is still another object of the present invention to provide an improved locker mounting apparatus that can support loads of at least 30 pounds.

It is still yet another objection of the present invention to provide an improved locker mounting apparatus that is simple and inexpensive to fabricate.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### BRIEF DESCRIPTION OF THE DRAWING

FIG. 1 is a perspective view of the present invention locker mounting apparatus for work belts coupled to a louvered vent of a locker door.

FIG. 2 is a partial side elevation view of a duty belt having two coupling members adapted to be supported by the present invention.

FIG. 3 is a front elevation view of the coupling members of a duty belt adapted to be supported by the present invention.

FIG. 4 is a front elevation view of the present invention.

FIG. 5 is a cross-sectional view of the present invention taken through line 5-5 of FIG. 4.

FIG. 6 is a partial cross-sectional view illustrating the preferred embodiment of the present and supported duty belt mounted on a louvered vent of a locker door.

FIG. 7 is a side elevation view of an alternative embodiment of the present invention.

FIG. 8 is a rear elevation view of the alternative embodiment of the present invention shown in FIG. 7.

FIG. 9 is a partial, cross-sectional view of the alternative embodiment of the present invention shown in FIGS. 7 and 8 mounted upon a locker door.

### DESCRIPTION OF THE PRESENTLY PREFERRED EMBODIMENT

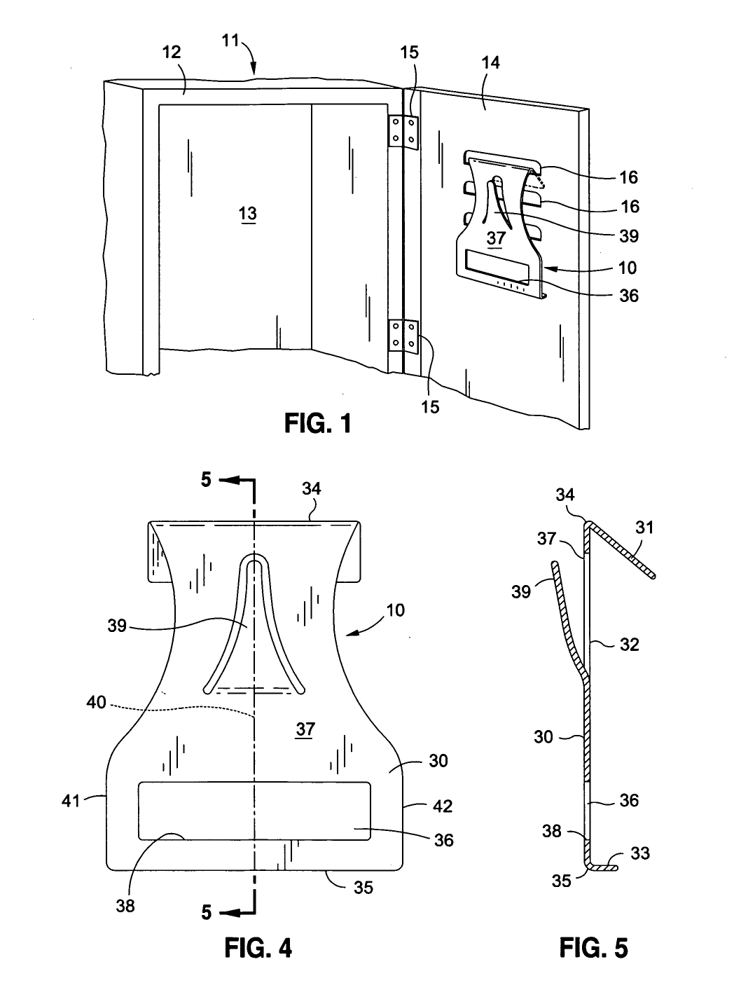

An understanding of the use of the present invention can be best seen by reference to FIG. 1. As shown in FIG. 1, the present invention locker mounting apparatus 10 is intended for use with a conventional locker, generally indicated by the reference numeral 11, having a frame 12, an interior locker cavity 13 and a locker door 14. The locker door 14 is attached by hinges 15 to frame 12 of the locker 11. The locker door 14 includes a plurality of equally spaced horizontally disposed projecting louvered vents 16 which extend across the surface of locker door 14. The vents 16 provide openings through which air may move between the interior cavity 13 and the exterior environment. As will be described in detail hereinbelow, the present invention locker mounting apparatus 10 is removably coupled to a vent 16 and will support a heavy duty or work belt within interior cavity 13.

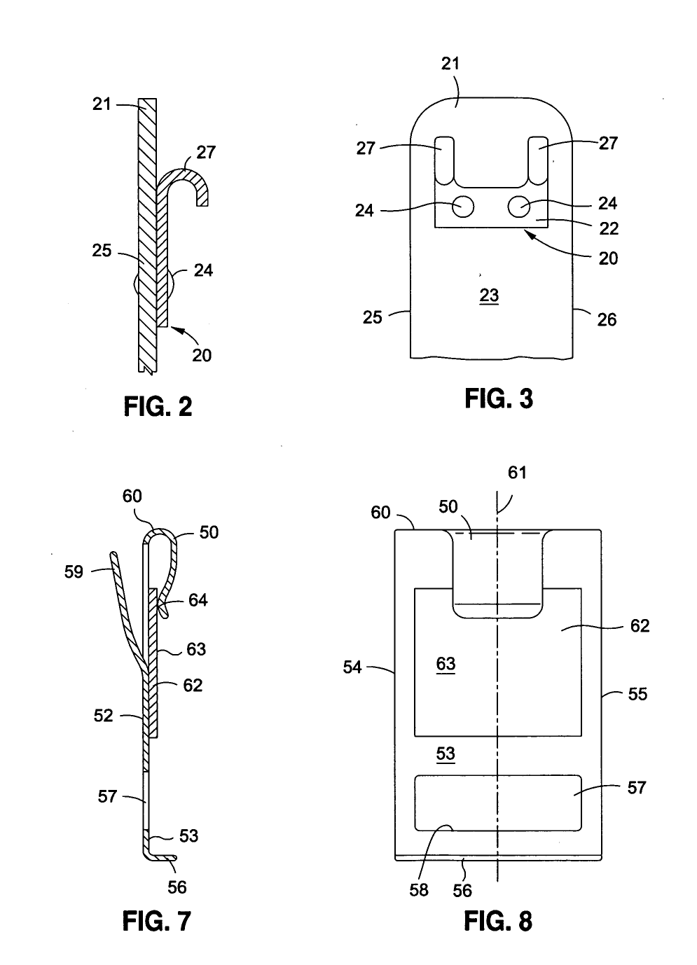

The present invention locker mounting apparatus 10 is specifically adapted to support the heavy duty or work belts used by law enforcement officers, members of the military and professions such as carpenters and plumbers. Specifically, the present invention locker mounting apparatus can support loads as heavy as 30 pounds. Typical work and duty belts in general and specifically those used by law enforcement officers typically employ a construction such as that illustrated in FIG. 2 and FIG. 3 wherein the portion of the work belt that is adapted to be coupled to the present invention is shown. The duty belt shown in FIG. 2 and FIG. 3 is a conventional belt long in use by law enforcement officers, members of the military and like professions and does not constitute any part of the present invention. As illustrated in FIGS. 2 and 3, belt coupling member 20 is secured to belt 21. Belt coupling 20 comprises a generally rectangular base 22 which is physically secured to surface 23 of belt 21 by rivets 24 to insure that belt coupling member 20 is properly secured to the surface 23 of belt 21 between parallel edges 25 and 26 by a pair of rivets 24 that the rivets 24 are imbedded through belt member 20 equidistant from the edges 25 and 26 of belt 21. The lateral edges of belt coupling 20 depend into a pair of hooked securing flanges 27 in parallel spaced relation to one another. Hooked securing flanges 27 are adapted to engage mating apertures disposed through the opposing end of duty belt 21 (not shown). It would be understood by those having skill in the art that the present invention is usable with work or duty belts that include a different number of hook securing flanges 27.

The structure of the preferred embodiment of the present invention can be best seen by reference to FIGS. 4-6, inclusive. The present invention is constructed from a planar sheet 30 of metal or molded plastic. The upper end of planar sheet 30 depends into a mounting flange 31 that is positioned at an oblique angle with respect to rear surface 32 of planar member 30. The lower end of planar member 30 depends into a spacing panel 33 that is perpendicular to rear surface 32. The upper interface 34 between flange 31 and planar member 30 and the lower interface 35 between spacing panel 33 and planar member 30 are in parallel spaced relation to one another. The geometrical configuration of planar member 30 is symmetrical with respect to its longitudinal axis 40. As can be seen best in FIG. 4, reciprocal lateral edges 41 and 42 extend between upper interface 34 and lower interface 35. The lower portions of lateral edges 41 and 42 are substantially parallel to each other and are perpendicular to upper interface 34 and lower interface 35. The distance between the upper portions of lateral edges 41 and 42 uniformly decrease from the mid-point of lateral edges 41 and 42 to their intersection with upper interface 34. Subject to the requirement that upper interface 34 must be mountable within a louvered vent 16, it would be understood by persons having skill in the art that other geometrical configurations for the upper portions of lateral edges 41 and 42 could be employed.

A rectangular aperture 36 is disposed through planar member 30 from the front surface 37 to the rear surface 32 thereof, the bottom edge 38 of rectangular aperture 36 being in parallel spaced relation to lower interface 35 and is adapted to receive hooked securing flanges 27 of belt coupling member 20. To provide means to mount clothing or other light items, auxiliary hook 39 is secured to front surface 37 between rectangular aperture 36 and upper interface 34 along the axis 40 of planar member 30. It is understood to those persons having skill in the art that, if planar member 30 is metal, auxiliary hook 39 can be formed from a partially severed and depending section of planar member 30.

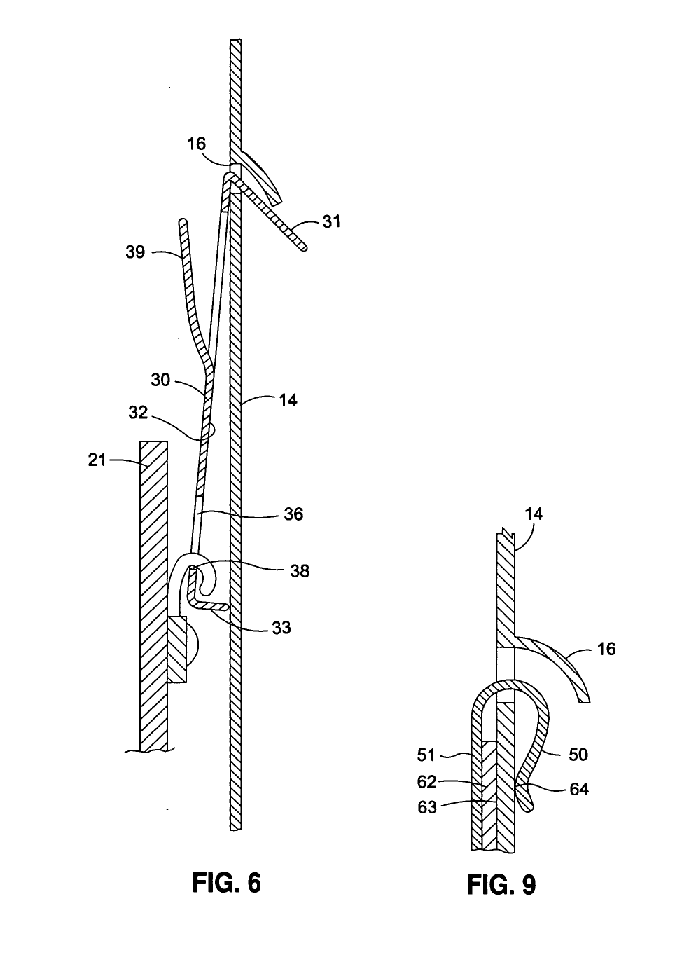

Use of the present invention can be best seen by reference to FIG. 6 which illustrates a mounted form of the present invention supporting a work belt. As shown in FIG. 1, mounting flange 31 is inserted through and is in engagement with a louvered vent 16 in locker door 14. When in position, spacing panel 33 is positioned against inside surface 37 of locker door 14 thereby creating a gap between the surface of locker door 14 and the portion of rear surface 32 adjacent rectangular aperture 36. To support work belt 21, hooked securing flanges 27 of belt coupling member 20 are disposed through rectangular aperture 36 and are disposed adjacent bottom edge 38 of rectangular aperture 36. When in place, the terminus of hooked securing flanges 27 will be positioned within the gap created between the inside surface 37 of locker door 14 and the rear surface 32 of planar member 30.

An alternative embodiment of the present invention can be best seen by reference to FIG. 7 and FIG. 8. In the preferred embodiment, mounting flange 31 is a rigid planar member that is obliquely positioned relative to the rear surface 32 of planar member 30. Where the surface of the locker door 14 that will be engaged by the present invention is smooth and may allow inadvertent movement when a work belt is mounted or removed, a mounting flange 50 in the form shown in FIGS. 7 and 8 is employed. The alternative embodiment of the present invention comprises a planar member 51 having a front surface 52, a rear surface 53 and reciprocal lateral edges 54 and 55. The lower portion of lateral edges 54 and 55 are substantially parallel to each other. The lower end of planar member 51 depends into a spacing panel 56 that is perpendicular to rear surface 53. A rectangular aperture 57 is disposed through planar member 51 from the front member 52 to the rear surface 53 thereof, the bottom edge 58 of rectangular aperture 57 being in parallel, spaced relation to spacing panel 56. As with the preferred embodiment of the present invention shown in FIGS. 4 and 5, to provide mounting for clothing or other light items, an auxiliary hook 59 is secured to front surface 52 between rectangular aperture 57 and upper interface 60 and positioned along longitudinal axis 61 of planar member 51. Upper interface 60 is parallel to bottom edge 58 of rectangular aperture 57 and spacing member 56.

The alternative embodiment of the present invention shown in FIGS. 7 and 8 employs a mounting flange 50 that is intended to apply force to the outside surface of the locker door to prevent inadvertent movement of the present invention when a work belt is mounted or removed. As shown in FIG. 7 and FIG. 8, a resilient pad 62 is secured to surface 53 of planar member 51 intermediate rectangular aperture 57 and upper interface 60 and is in alignment with longitudinal axis 61. As will be described in detail hereinbelow, a non-slip surface 63 of resilient pad 62 is adapted to engage the inside surface 37 of locker door 14. Mounting flange 50 extends from upper interface 60 in opposition to front surface 52 of planar member 51, mounting flange 50 being resiliently deformed to enable it to apply a resilient force. As shown in FIG. 7, in its quiescent state, engagement surface 64 of mounting flange 50 will be in resilient engagement with surface 63 of resilient pad 62.

The mounting of the alternative embodiment of the present invention as shown in FIGS. 7 and 8 on locker door 14 can be best seen by reference to FIG. 9. Mounting flange 50 is disposed through a louvered vent 16 whereby engagement segment 64 of mounting flanges 50 is forcefully in contact with the outer surface of locker door 14. The force applied by engagement segment 64 against the outer surface of locker door 14 urges surface 63 of resilient pad 62 to be in firm engagement with the inner surface 37 of locker door 14 thereby preventing inadvertent movement of the present invention locker mounting apparatus upon the mounting or removal of a work belt therefrom.

1. A locker mounting apparatus for a work belt incorporating at least one securing flange and to be engaged with a locker having a set of projecting louvered vents formed in a door of the locker for ventilation of the interior cavity of the locker, said locker mounting apparatus comprising:
(a) a planar member having front and rear surfaces and top and bottom edges, said top and bottom edges being in parallel spaced relation with one another, and an aperture being disposed through said planar member from the front to the rear surface thereof intermediate the top and bottom edges of said planar member, said aperture being adapted to receive and engage a securing flange of the work belt;
(b) mounting means extending rearwardly from the rear surface of said planar member at the top edge thereof for coupling said planar member to a louvered vent in the door of the locker; and
(c) spacing means depending from the rear surface of said planar member at the bottom edge of said planar member for displacing the rear surface of said planar member from the door of the locker.

2. A locker mounting apparatus for a work belt as defined in claim 1 wherein said mounting means is a planar panel integral and depending outwardly and down-wardly from the top edge of said planar member and being obliquely positioned with respect to the rear surface of said planar member.

3. A locker mounting apparatus for a work belt as defined in claim 1 wherein said mounting means comprises a mounting flange extending from the top edge of said planar member, said flange being a U-shaped resilient extension of said planar member, said flange having an end section that is flexibly disposed against the rear surface of said planar whereby force is exerted against the rear surface of said planar member by the end section of said mounting flange.

4. A locker mounting apparatus for a work belt as defined in claim 3 including a resilient pad secured to the rear surface of said planar member and positioned beneath the end section of said mounting flange.

5. A locker mounting apparatus for a work belt as defined in claim 1 wherein said spacing means comprises a linear panel extending perpendicular to the rear surface of said planar member.

6. A locker mounting apparatus for a work belt as defined in claim 1 including an upwardly extending mounting hook secured to the front surface of said planar member intermediate said mounting means and the aperture disposed through said planar member.

7. A locker mounting apparatus for a work belt as defined in claim 1 including a mounting hook integral with said planar member and extending outwardly and upwardly from the front surface of said planar member.

8. A locker mounting apparatus for a work belt incorporating at least one securing flange and to be engaged with a locker having a set of projecting louvered vents formed in a door of the locker for ventilation of the interior cavity of the locker, said locker mounting apparatus comprising:
(a) a planar member having front and rear surfaces and top and bottom edges, said top and bottom edges being in parallel spaced relation with one another, an aperture being disposed being through said planar member from the front to the rear surface thereof intermediate the top and bottom edges of said planar member, said aperture defining a lower edge that is in parallel spaced relation to the bottom edge of said planar member, the lower edge being adapted to receive and engage a securing flange of the work belt;
(b) a mounting planar panel being integral with the top edge of said planar member and depending outwardly and downwardly from the top edge of said planar member being obliquely positioned with respect to the rear surface of said planar member, said planar panel and being adapted to engage upon a louvered vent in the door of the locker; and
(c) a spacing flange adapted to engage the door of the locker integral with said planar member and extending rearwardly perpendicular to the rear surface of said planar member.

9. A locker mounting apparatus for a work belt as defined in claim 8 including an upwardly extending mounting hook secured to the front surface of said planar member intermediate said mounting means and the aperture disposed through said planar member.

10. A locker mounting apparatus for a work belt as defined in claim 8 including a mounting hook integral with said planar member and extending outwardly and upwardly from the front surface of said planar member.
